(19) United States
(12) Patent Application Publication
(10) Pub. No.: US 2018/0012505 A1
(43) Pub. Date: Jan. 11, 2018

(54) System and Methods for Real-Time Virtual Visual In-Route Vehicle Monitoring

(71) Applicant: Robert George Coghlan, Hialeah, FL (US)

(72) Inventor: Robert George Coghlan, Hialeah, FL (US)

(21) Appl. No.: 15/202,678

(22) Filed: Jul. 6, 2016

(51) Int. Cl. G08G 5/00; G01S 19/42

(52) U.S. Cl. CPC G08G 5/0082; G08G 5/0026; G01S 19/42; G08G 5/0013

(57) ABSTRACT

System and methods for real-time virtual visual in-route vehicle monitoring. System and methods herein provide novel means of monitoring global positioning equipped vehicles, in that tamper-proof identifiers registered on vehicle topsides are electronically imaged by aerospace imaging devices, including manned or unmanned aerospace vehicles or satellites. Transponders of in-route vehicles and aerospace imaging devices correspond, said digital images digitally relay to parabolic antennas, relay to connected networks such as the World Wide Web, are transmitted therein and interfaced in real-time via end-users utilizing computerized devices and applications for purposes of real-time virtual visual in-route vehicle monitoring. Crowdsourced end-users are supplied directives and means via a computerized application alert icon to engage said alert icon in order to alert authorities upon occurrences of specified events such as, vehicle well-being concerns, security or terrorism events.

### BACKGROUND

The current invention relates to the technical field of in-route vehicle monitoring.

In relation to subject matter in the field of endeavor of in-route vehicle monitoring problems are exhibited in the current state of technology within such field. Such exhibited problems include in-route vehicles, such as aircraft, which are monitored by personal range of vision, GPS tracking systems, ‘Air Navigation Service Providers’ (ANSPs), or radar systems, all of which have limited means of real-time visually monitoring aircraft, and limited or no integrated means to alert authorities upon occasion of specified events. The current invention is drawn towards enhancements of such limited means, as it affords the ability to virtually visually monitor in-route vehicles, such as an aircraft, for purposes of logistics, and provides integrated means to alert authorities upon occurrence of specified events constituting the nature of vehicle well-being interests, security or terrorism events.

In lieu of recent incidents whereupon aerospace vehicles went out of contact, were lost at sea, or crashed with no real-time virtual visual electronic imaging reference, and limiting facility to access reason as to why such vehicles were in the process of being lost, investigators had reductive data to perform investigative procedures, thus limiting time-sensitive rescue and investigative efforts. Unexpected deviations of flight plans, inclusive of said recent incidents, could not be real-time virtual visually monitored of actual in-route aircraft for situational awareness, and attempts to communicate with aircraft failed. For these matters, problems in the field of endeavor, in-route vehicle monitoring, need to be addressed, and its systems and methods enhanced.

Aircraft call-signs are conventionally displayed on the sides of an aircraft's main fuselage, tail or engine covering via paint medium or adhesive backed material. Display of ‘call-signs’ on an aircraft's sides provides for an aircraft to be readily identified when it is within visual range of ground personnel. Placement of call-signs on aircraft's fuselage, tail or engine covering do little however to afford observation of aircraft while airborne and in-route, as aircraft are generally at altitude and cruising speed and out of ground-based personnel's visual range.

Technology assembled and utilized in a manner described in the current invention makes available identifying of in-route vehicles and provides real-time virtual visual monitoring for persons who are not in direct visual range of in-route aircraft. Identifiers, in the case of an aircraft, its call-signs, are displayed prominently on its topside, to some measure, the length and width of its fuselage, and have qualities such as contrasting coloration combinations and reflectivity for high visibility day and night with available ambient lighting, and/or are composed of electronic lighting. Such qualities maximize imaging effects of said in-route vehicles, upon the current invention's example, an aircraft.

Given an in-route vehicle in distress, such as an aircraft, is time-sensitive with respects to condition and location, current monitoring systems are under-staffed and ill-equipped to provide expedient, accurate response which may result in saving of life. Human cognitive awareness in the form of real-time virtual visual monitoring of in-route vehicles and an associated system integrated with ability to alert authorities is the prescribed enhancement to current state of technology of monitoring in-route vehicles and is systematically methodized in the current invention. Such invention transforms the means of conventional systems of persons passively tracking in-route vehicles on computerized applications, into dynamic real-time interactive processes.

ANSPs understaffed and over-burden with the task of air-traffic monitoring, cannot virtually visually monitor all in-route vehicles. What is needed is a system for real-time crowdsourced cognitive human virtual visual monitoring of in-route vehicles. The current invention addresses and provides for this matter via crowdsourcing techniques, in so a single or plurality of individuals or entities, such as a private or governmental agency, may monitor in-route vehicles. As described in the current inventions embodiments, a system and methods of electronically imaging in-route identified vehicles and real-time relaying such electronic images through interconnected systems coupled with end-user's human cognitive ability to interface said system and methods via computerized applications available on devices such as smartphones or computers provides crowdsourced persons, thus, supplements agencies tasks.

Crowdsourcing is an integral component of the current invention and by means prescribed herein such is performed privately by presenting an optional percentile surcharge on ticketing passengers and allotting a numeric code and according such code to a relation(s) of the ticketing passenger. Relation(s) of ticketing passengers are thereby ‘crowdsourced’ and may monitor in-route vehicles in manners described within the embodiments of the present invention. Others, such as authorities, are provided said system and methods and may also participate in such processes. Thus, resolving the aforementioned current state of the art problems of understaffing in the said field of endeavor as a greater plurality of cognitively aware and real-time virtually visually equipped persons or entities may monitor in-route vehicles, such as aircraft for the continuum of flight, for purposes described herein.

### SUMMARY OF THE INVENTION

The current invention addresses the need for enhanced monitoring of in-route vehicles. In substance, the nature of its general system and methods provide supplemental cognitive human presence of real-time virtual visual monitoring of in-route vehicles. The current invention comports an integrated system and methods configured for end-users to alert authorities upon occasion of addressing in-route vehicle well-being, security or terrorism events. Such system and methods objective of real-time virtual visual monitoring of in-route vehicles and integrated computerized application configured to alert authorities advantages itself beyond current methods.

Advantages of registration of vehicle call-signs as identifiers on their topside and system and methods of virtual visual monitoring as defined within the current invention, provides for identifying and monitoring vehicles. Exact identity of a vehicle, in the current invention's preferred embodiment, an aircraft, will be known precisely at all times in lieu of such method. A method of crowdsourcing overcomes previously described understaffing. A method of application of call-signs utilizing paint mediums and electronics provide visualization day and night, and effectively establishes the system and methods as tamper-proof.

The best mode of the current invention incorporates its system and methods set forth in the current art by way of virtual visual monitoring of in-route vehicles. In the current invention, such pertains to a vehicle configured accordingly to an embodiment of the invention. Upon this instance, such vehicle is an aircraft. The referenced embodiment are identifiers registered on the topside of the aircraft's main fuselage. Identifiers are correlated to the aircraft's “call-signs” and displayed in a visually prominent manner. The ways, means and usage of material to register identifiers would be consistent with required governmental aviation transportation authority's specifications and applicable toward the objective of the current invention

Within the illustrated preferred embodiment, an in-route aircraft is being virtually visually monitored by a plurality of end-users. Means established in the current art of digitally imaging an in-route vehicle by an aerospace vehicle and transmitting such images to terrestrial based parabolic antenna which transfer such images to computer servers connected to the World Wide Web, which transfer such images to cellular towers and of which is accessed by said end-users for said virtual visual in-route vehicle monitoring and alerting authorities on occasion of specified events, is the best mode of the current invention's practice. Thus, the best mode of practice advances the cause of the endeavor of the field of monitoring in-route vehicles by enhancing the cause of monitoring of in-route vehicle's logistics and safety and terrorism events, as a plurality of crowdsourced end-users are dedicated to such cause.

Understanding embodiments of the current invention as extending beyond the range and scope of the field of civil aviation utilization denotes the invention as encompassing a plurality of purposes which may extend to public transportation vehicles such as buses, trains, taxis, school buses and the like. Such extension embodies civilians monitoring in-route aircraft and a plurality of transportation vehicles and augmenting authorities monitoring. Hence, said invention contains capacity for civilians to engage with the current invention in such manner as to alert authorities in lieu of specified events. Said embodiments thereof provide a tertiary level of monitoring vehicles, in that the system is real-time populated with persons of whom are cognitively aware of the well-being of in-route vehicles through the duration of route.

Worldwide air traffic is increasing year over year and authorities are not staffed well enough to individually virtually visually monitoring each airborne aircraft during the duration of its flight. Airlines currently rely on ANSP's, which monitor in-route aircraft and contain ‘gaps’ in aircraft monitoring systems. Current technologies will be materially enhanced by the current invention in that electronic imaging data will provide means to assess such concerns of drone buzzing, laser pointing and hijacking of aircraft. The current invention therefore converts passive monitoring of a representative icon on a computerized device of an in-route aircraft by civilians, into proactive monitoring, and supplements addressing the aforementioned concerns.

Affording a plurality of persons, of whom meet identity criteria, training and certification standards, understood herein as, “End-users”, such technology to virtually visually monitor in-route vehicles, notably aircraft worldwide, is a major aspect of the invention's methodology. Such procedures distinguish the current invention from prior art and provide a novel state of the art means to advance the cause of the purposes in its field of endeavor. Should such specified methods as described in the current invention's embodiments be utilized to alert authorities upon occurrence of security or terrorism events, such would be understood as a main utility of the current invention. Means then of alerting authorities in real-time by a plurality of said end-users, crowdsourcing′ of whom are virtually visually monitoring in-route aircraft and supplied a system integrated with direct communication to authoritative entities contributes to swift response to distressed vehicles, and as such, materially contributes to countering terrorism.

In summation, the purpose of the invention is to make widely available such enabling technology of real-time virtual visually monitoring of in-route vehicles together with an interactive application for purposes of logistics, vehicle well-being, and for notification of authorities upon occurrence of security and terrorism events. As such, logistical efficiency, response in lieu of vehicle well-being, and safety and counter-terrorism efforts are enhanced.

### BRIEF DESCRIPTION OF THE DRAWINGS

FIG. 1 illustrates a topside view of a vehicle, in the current example, a daytime sunlit operational in-route aircraft, with its identifiers registered with paint mediums upon its topside.

FIG. 2 illustrates a topside view of the vehicle referenced in FIG. 1, with alternately its identifiers registered with light emitting diodes upon its topside.

FIG. 3 illustrates a topside view of the vehicle referenced in FIG. 1, with alternately its identifiers registered with paint mediums and light emitting diodes upon its topside.

FIG. 4 illustrates a nighttime low available ambient lighting operational view of an in-route vehicle referenced in FIG. 2, alternatively registered with light-emitting diodes on the topside of its fuselage.

FIG. 5 illustrates a nighttime low ambient light operational view of an in-route vehicle referenced in FIG. 3, alternatively registered with its identifiers as paint mediums with photo-reflective qualities and Light Emitting Diodes (LEDs) on the topside of its fuselage.

FIG. 6 illustrates a portside lateral view of a daytime sunlit operational in-route aircraft referenced in FIG. 1 with its identifiers registered on its topside.

FIG. 7 illustrates an aerospace vehicle, in the current example, an electronical imaging and global positioning system equipped satellite.

FIG. 8 illustrates a terrestrial based parabolic antenna and connections to the network of the World Wide Web.

FIG. 9 illustrates computerized servers and connections to the network of the World Wide Web.

FIG. 10 illustrates a cellular tower, antennae, transceivers and digital signal processors and connections to the network of the World Wide Web.

FIG. 11 illustrates a portside lateral view of the daytime operation of the in-route aircraft referenced in FIG. 1. its identifiers registered on the topside of its fuselage with its electronical communications and global positioning system (GPS) in operational mode and trans-ponding in-route aircraft parameters and imaging data with the aerospace vehicle referenced in FIG. 7.

FIG. 12 illustrates a portside lateral view of the daytime operation of the in-route aircraft referenced in FIG. 1. its identifiers registered on the topside of its fuselage and with its electronical communications and global positioning system (GPS) in operational mode and trans-ponding in-route aircraft parameters and imaging data with the aerospace vehicle referenced in FIG. 7 and being electronically imaged by vehicle referenced in FIG. 7.

FIG. 13 illustrates a terrestrial based parabolic antenna trans-ponding with an electronical imaging and global positioning system equipped satellite.

FIG. 14 illustrates a terrestrial based parabolic antenna connected to computerized servers that are connected to the network of the World Wide Web and interchanging data therein.

FIG. 15 illustrates a cellular tower, antennae, transceivers and digital signal processors in operational mode, connected to network servers which are connected to the network of the World Wide Web.

FIG. 16 illustrates said cellular tower, an end-user, or, a plurality of end-users as denoted by the expression (29× plurality), end-user's electronic device, a cellular tower and end-user's electronic device and cellular tower in operational mode and transponding.

FIG. 17 illustrates, an electronic device of an end-user, an end-user or a plurality of end-users as denoted by the expression (29× plurality), in operational mode and displaying a virtual visual image, flight line, parameters of in-route vehicle, directives, alert icon and end-user's electronic device in operational mode and transponding with said cellular tower.

FIG. 18 Illustrates an electronic device, in the current example, a cellular telephone, also known as a ‘smartphone’, in operational mode and transponding with said cellular tower and being held by an end user or a plurality of end-users as denoted by the expression (29× plurality) and displaying a virtual visual image and parameters of in-route vehicle, directives and end-user engaging alert icon.

FIG. 19 Illustrates an authoritative entity(s) receiving, reviewing and acting upon real-time virtual visual vehicle data sent by an end-user or said plurality of end-users and displayed on authority entity's computerized device.

### DETAILED DESCRIPTION OF THE DRAWINGS

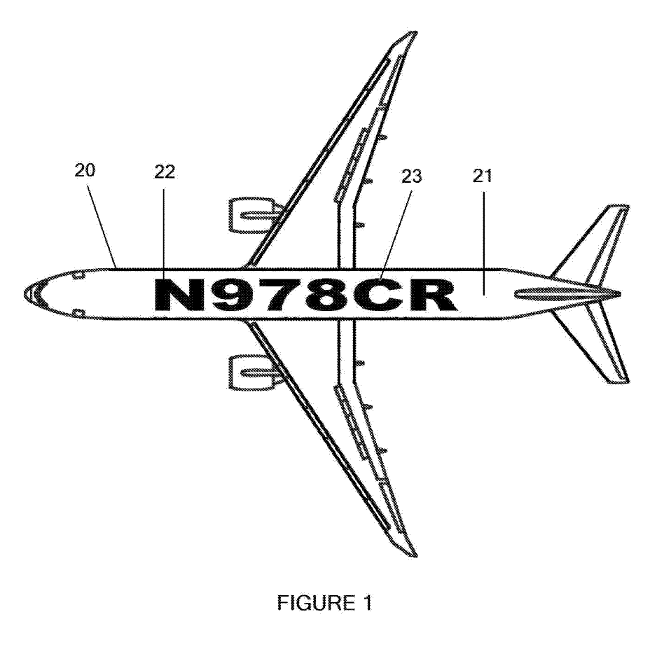

FIG. 1 illustrates a topside view representing a daytime sunlit operational in-route vehicle 20, an aircraft, registered with its identifiers 22 on the topside of its fuselage 21. The vehicle's identifiers 22 are correlated to the vehicle's ‘call-signs’, and are herein designated as ‘identifiers’ 22. The medium utilized for registration of its identifiers are paint mediums with photo reflective qualities 23. The height of its identifiers 22 would be relative to 16 feet 0 inches in height and 98 feet 3 inches in length. The vehicle 20 is a Boeing 777 class model aircraft, at cruising speed of 560 mph and cruising altitude of 35,000 feet. The aircraft's 20 dimensions are; 209 feet and 1 inch in length, 199 feet 11 inches in wingspan, and its fuselage width is 20 feet 4 inches.

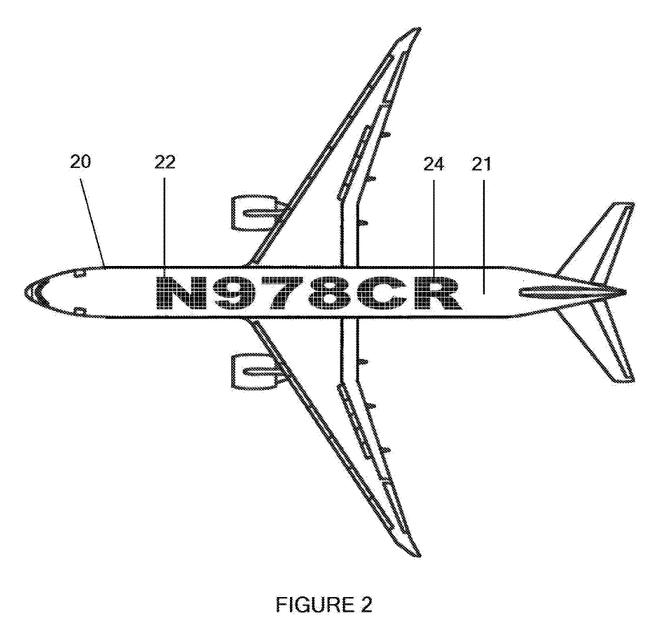

FIG. 2 illustrates a topside view represents a daytime sunlit operational in-route vehicle 20 with its identifiers 22 on the topside of its fuselage 21. The medium utilized alternately for registration of identifiers 22 are Light-Emitting Diodes (LEDs) 24. Alternating electronical medium means are applicable, such as Liquid-Crystal Display (LCD), engineered to best accommodate the systemized methods of enclosed art in the current invention. The height of the aircraft's identifiers 22 are relative to 17 feet 0 inches in height and 99 feet 3 inches in length. The aircraft 20 is a Boeing 777 class model, at cruising speed of 560 mph and cruising altitude of 35,000 feet. The aircraft's dimensions are; 209 feet and 1 inch in length, 199 feet 11 inches in wingspan, and its fuselage width is 20 feet 4 inches.

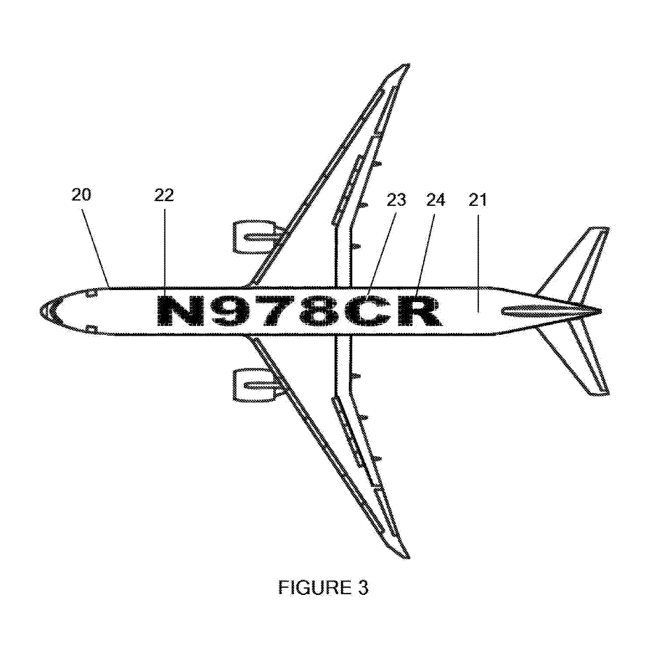

FIG. 3 illustrates a daytime sunlit operational view of an in-route vehicle 20 registered with its identifiers 22 on the topside of its fuselage 21. The mediums utilized alternately for registration of identifiers 22 are paint mediums with photo-reflective qualities 23 and light-emitting diodes 24. Alternate paint and electronical mediums means are applicable as well as alternating electronic mediums such as liquid-crystal display, engineered to best accommodate the methods of the enclosed art in the current invention. The height of the aircraft's identifiers 22 are relative to 17 feet 0 inches in height and 99 feet 3 inches in length. The aircraft 20 is a Boeing 777 class model, at cruising speed of 560 mph and cruising altitude of 35,000 feet. The aircraft's dimensions are; 209 feet and 1 inch in length, 199 feet 11 inches in wingspan, and its fuselage width is 20 feet 4 inches.

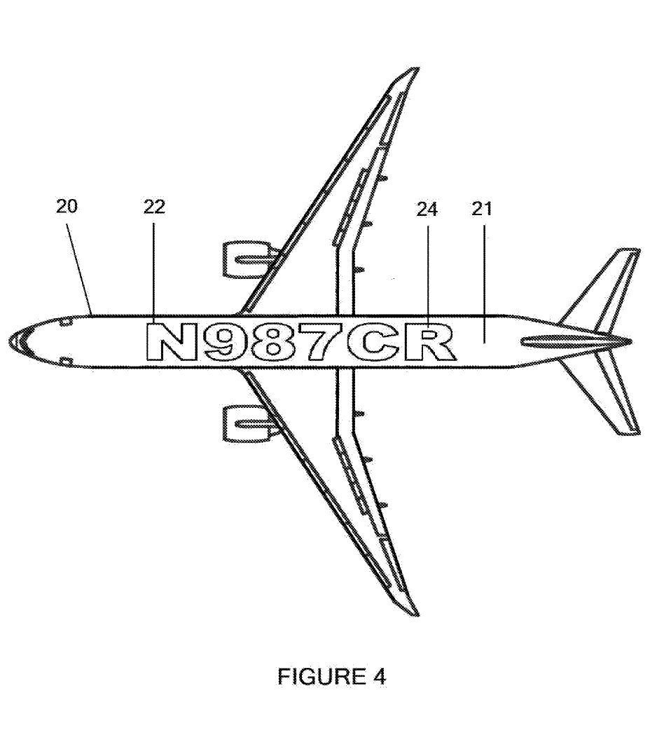

FIG. 4 illustrates a nighttime low available ambient lighting operational view of an in-route vehicle 20 registered with its identifiers 22 on the topside of its fuselage 21. Identifiers 22 are registered with light-emitting diodes 24 of which are operationally electronically illuminated. The aircraft 20 is a Boeing 777 class model, at cruising speed of 560 mph and cruising altitude of 35,000 feet. The aircraft's dimensions are; 209 feet and 1 inch in length, 199 feet 11 inches in wingspan, and its fuselage width is 20 feet 4 inches. The height of its identifiers 22 is relative to 17 feet 0 inches in height and 99 feet 3 inches in length.

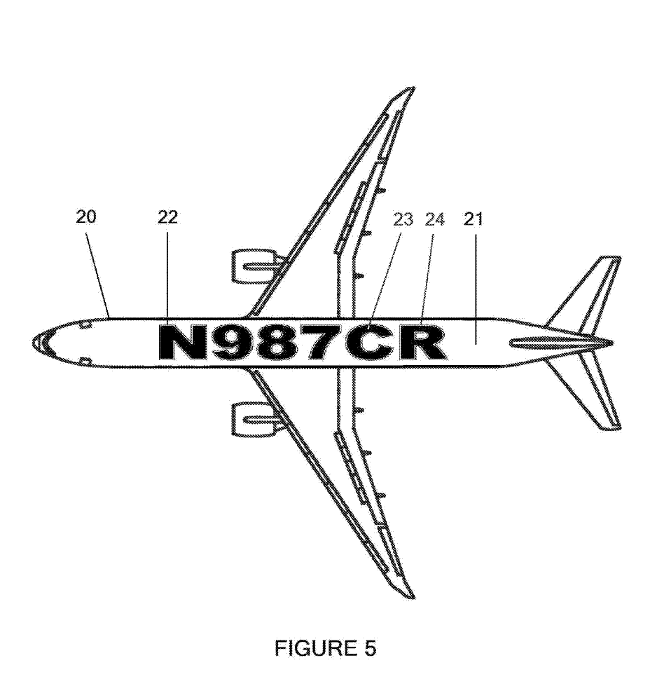

FIG. 5 illustrates a nighttime low ambient light operational view of an in-route vehicle 20 registered with its identifiers 22 on the topside of its fuselage 21. The mediums utilized for registration of identifiers 22 are paint mediums with photo-reflective qualities 23 and light-emitting diodes 24 of which are operationally electronically illuminated. Alternating paint and electronical mediums means are applicable as well as alternating electronic mediums such as liquid-crystal display, engineered to best accommodate methods of enclosed art in the current invention. The height of the aircraft's identifiers 22 are relative to 17 feet 0 inches in height and 99 feet 3 inches in length. The aircraft 20 is a Boeing 777 class model, at cruising speed of 560 mph and cruising altitude of 35,000 feet. The aircraft's dimensions are; 209 feet and 1 inch in length, 199 feet 11 inches in wingspan, and its fuselage width is 20 feet 4 inches.

FIGS. 1, 2, 3, 4 and 5 illustrate high contrasting qualities between identifier 22 coloration and fuselage topside 21 coloration. Identifier methods 22, 23, 24 and fuselage topside 21 contrasting coloration maximize visibility during daytime operations. Electronical illumination of light-emitting diodes 24 provide maximum visual perception during nighttime operations. Upon all instances, visual perception of electronic imaging such as digitized photographic processes are prominent. Images, such as digitized photographs, display visually prominently on end-user's computerized devices. Identifier mediums may also be compromised of adhesive backed materials, such as reflective vinyl and materials engineered for aerospace signage.

Identifiers 22 are correlated to individual vehicle's ‘call-signs’. Within the preferred embodiment, the call-signs, “N987CR” are utilized for purpose of illustration. Any resemblance of such to actual vehicle identifying call-signs is considered coincidental. Vehicle identifying call-signs will vary and match amongst vehicles in such manners consistent with identifying individual vehicles.

Font stylization of identifiers 22 in the preferred embodiment is, “Arial Black”, capitalized and registered in the color ‘Black’ on the vehicle's fuselage topside 21 and elongated to size. Orientation of methods of registering identifiers on vehicle's topsides exist, though in the current embodiment, the identifier 22 is registered in a manner legible from the front of the vehicle to the aft while viewed from its portside. Font stylization and orientation may vary and register in a manner consistent with operational interests of varying vehicles.

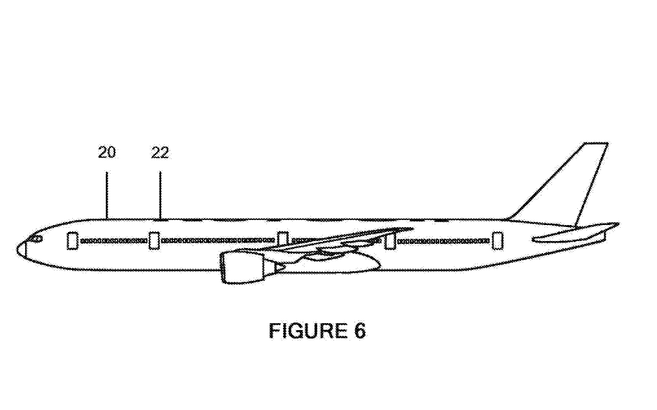

FIG. 6 illustrates a portside lateral view of the daytime sunlit operational mode of in-route vehicle 20 and its identifiers 22.

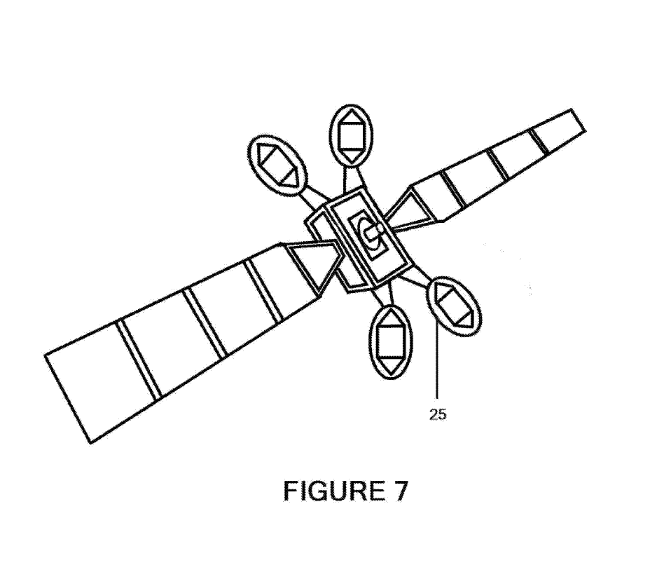

FIG. 7 illustrates an aerospace vehicle, in the current example, an electronical imaging and global positioning system equipped satellite 25. The vehicle 25 is positioned at operational altitude and operational.

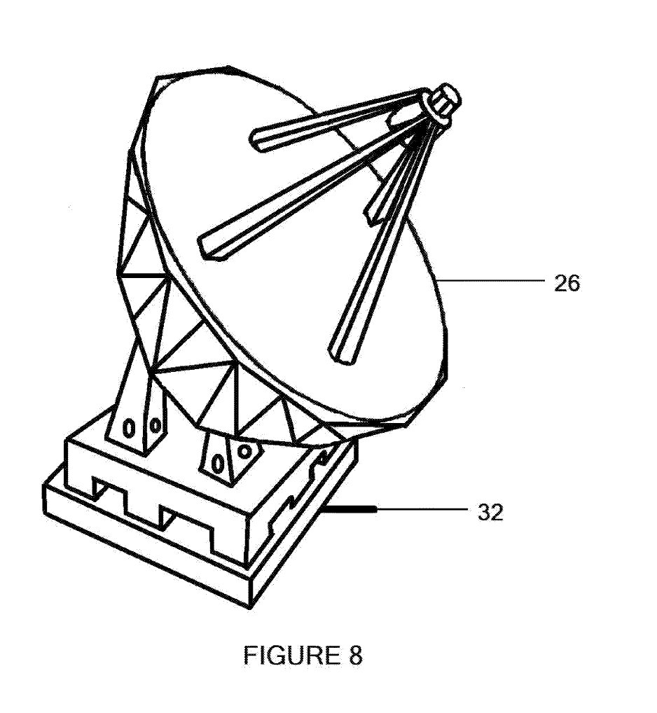

FIG. 8 illustrates a terrestrial based operational parabolic antenna 26 in operational mode and connected to the network of the World Wide Web 32.

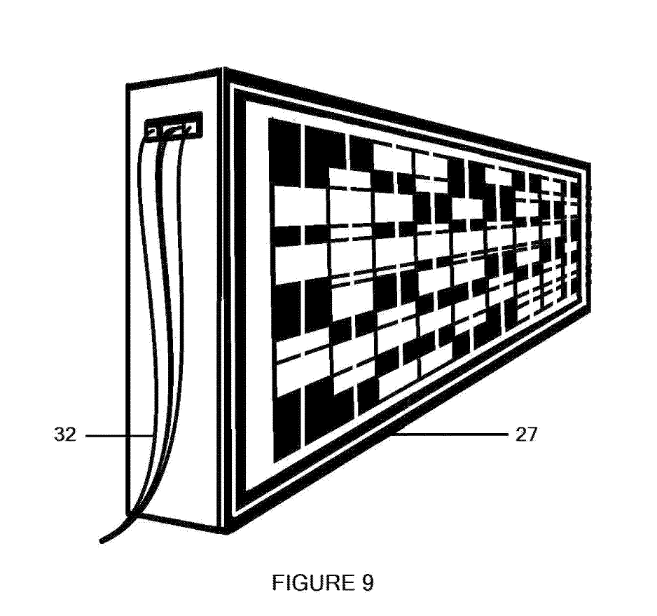

FIG. 9 illustrates operational computerized servers 27 connected to the network of the World Wide Web 32.

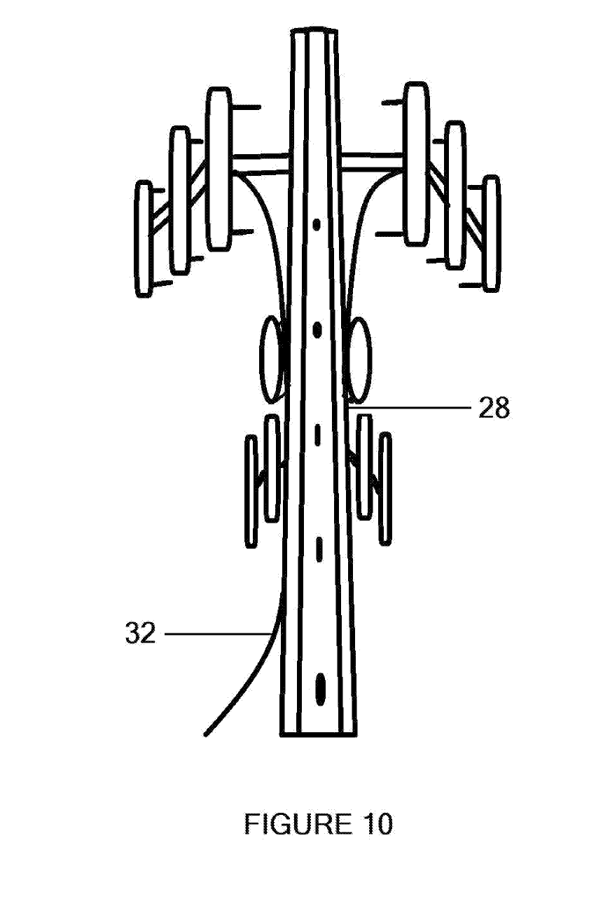

FIG. 10 illustrates an operational cellular tower, antennae, transceivers and digital signal processors 28 and connection to the network of the World Wide Web 32.

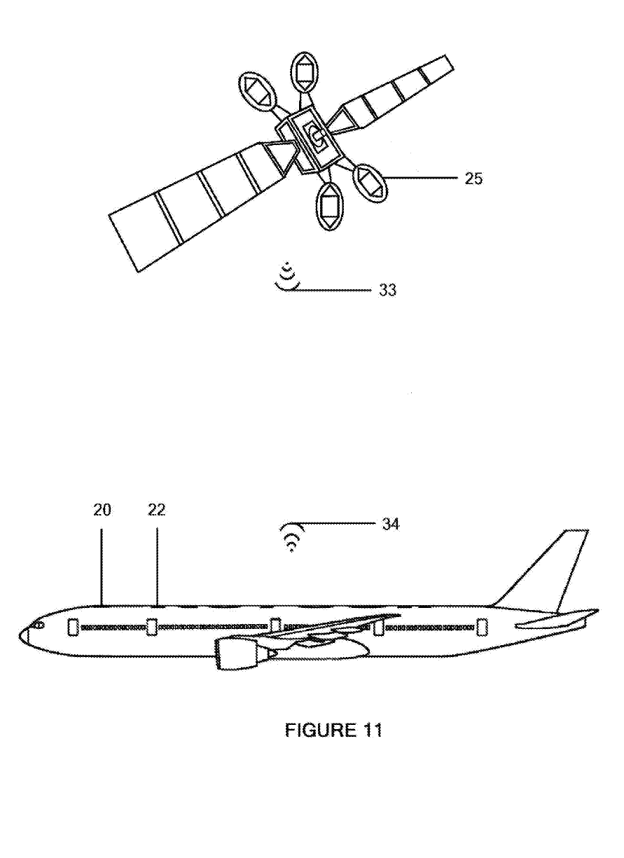

FIG. 11 illustrates a portside lateral view of the daytime operational in-route vehicle 20, its identifiers 22, and its electronical communications and global positioning system (GPS) in operational mode and transponding (34, 33), its in-route aircraft 20 position and parameters with aerospace vehicle 25; an electronical imaging and global positioning system equipped satellite similarly transponding (33, 34).

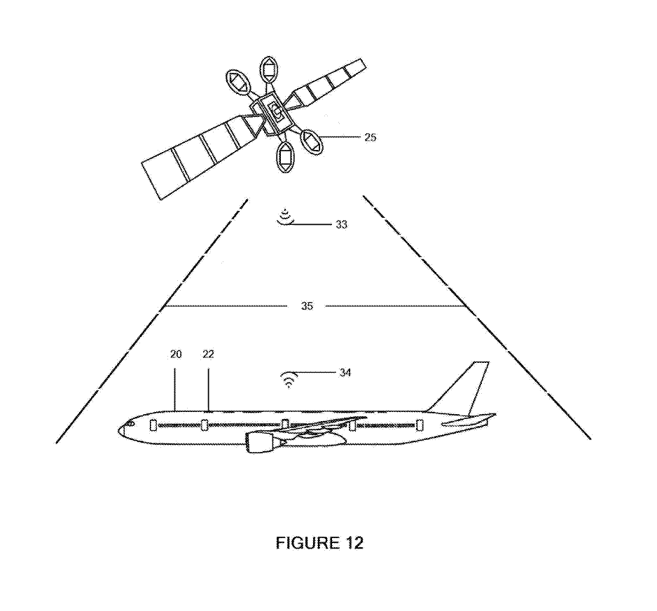

FIG. 12 illustrates a portside lateral view of the daytime operation of the in-route vehicle 20, its identifiers 22 and its electronical communications and global positioning system (GPS) in operational mode and transponding (34, 33) in-route vehicle 20 position and parameters with aerospace vehicle 25 and being electronically imaged by vehicle 25; an electronical imaging and global positioning system equipped satellite similarly transponding (33, 34).

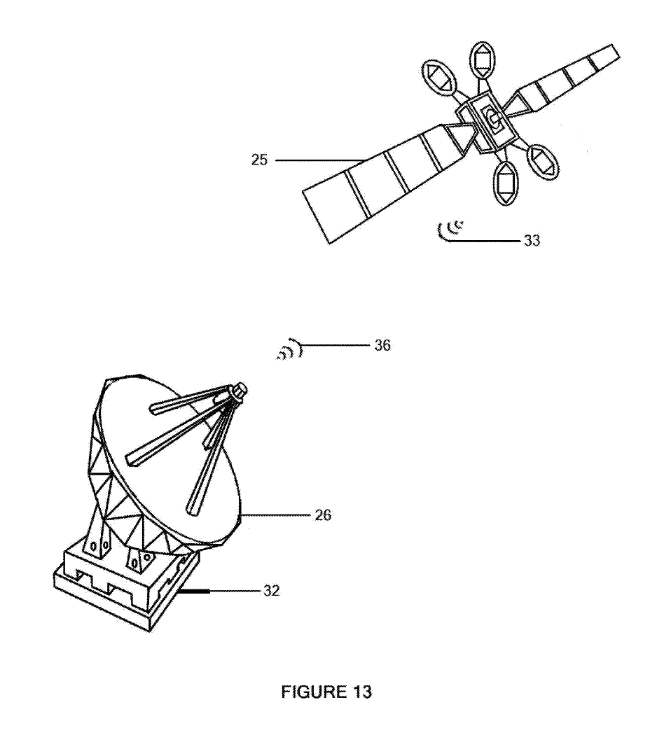

FIG. 13 illustrates a terrestrial based parabolic antenna 26 in operational mode and transponding (36, 33) with an electronical imaging and global positioning system equipped satellite 25, positioned at operational altitude, operational, and similarly transponding (33, 36).

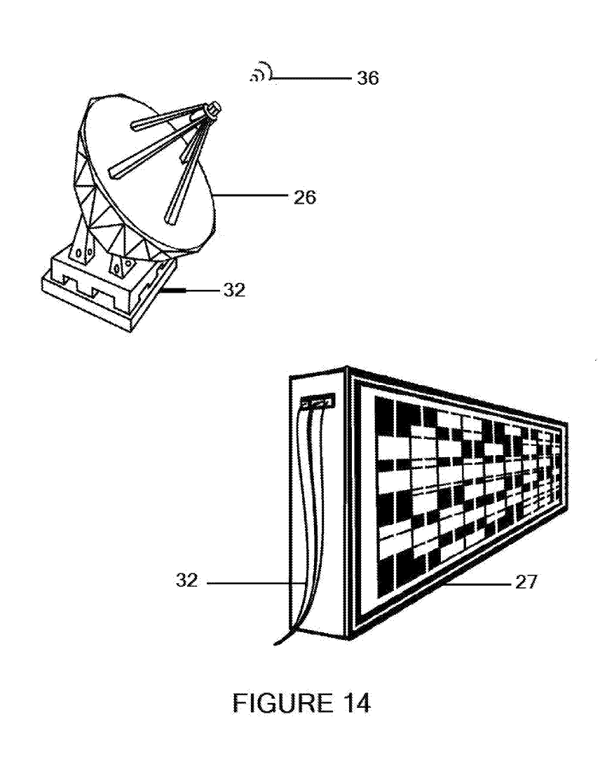

FIG. 14 illustrates a terrestrial based parabolic antenna 26 in operational mode, transponding (36, 33) with an electronical imaging and global positioning system equipped satellite 25 and connected to computerized servers 27, of which are connected to the network of the World Wide Web 32.

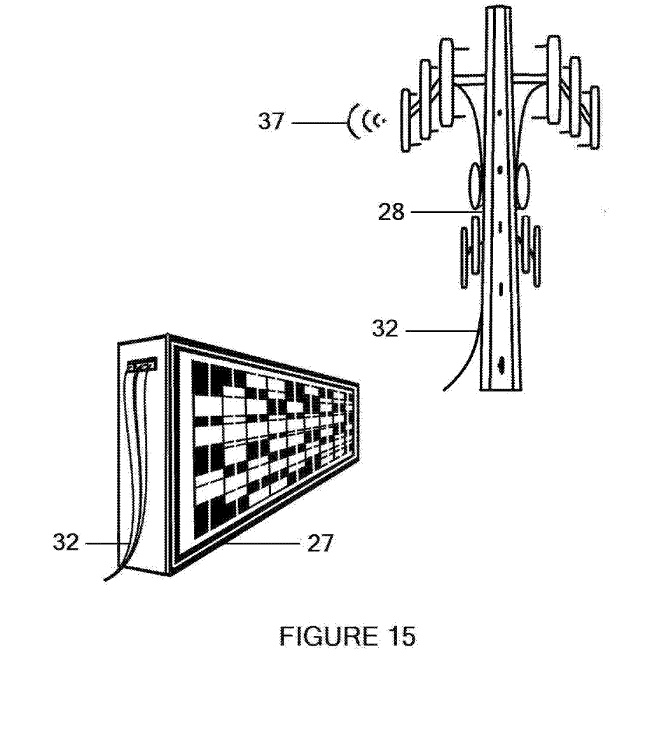

FIG. 15 illustrates a cellular tower inclusive of antennae, transceivers and digital signal processors in operational mode 28, connected to the network of the World Wide Web 32 and interchanging data with computerized network servers 27.

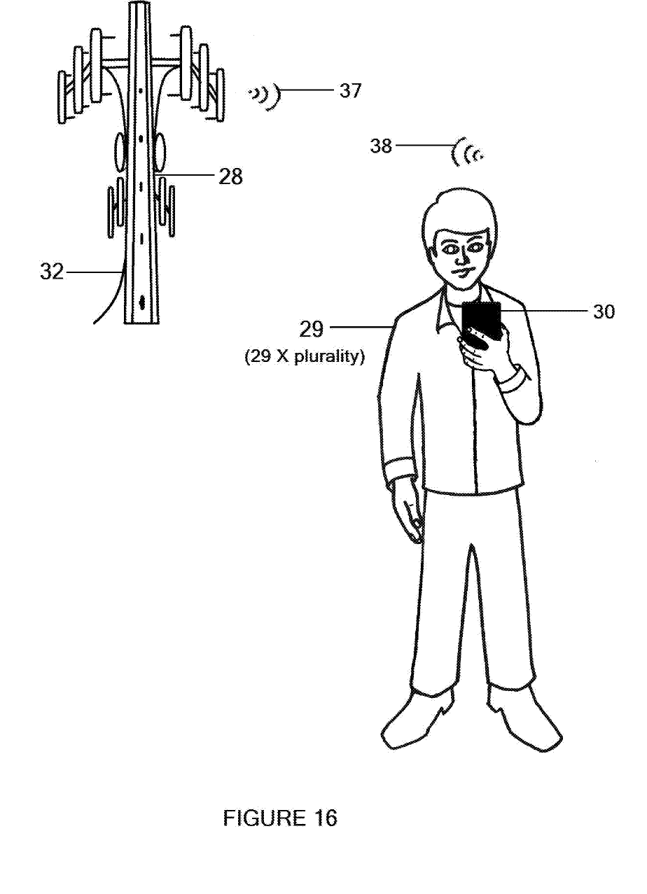

FIG. 16 illustrates a cellular tower 28 in operational mode, connected to the network of the World Wide Web 32 and computerized servers 27 and transponding (37, 38) with end user's 29 electronic device 30 of which is similarly transponding (38, 37).

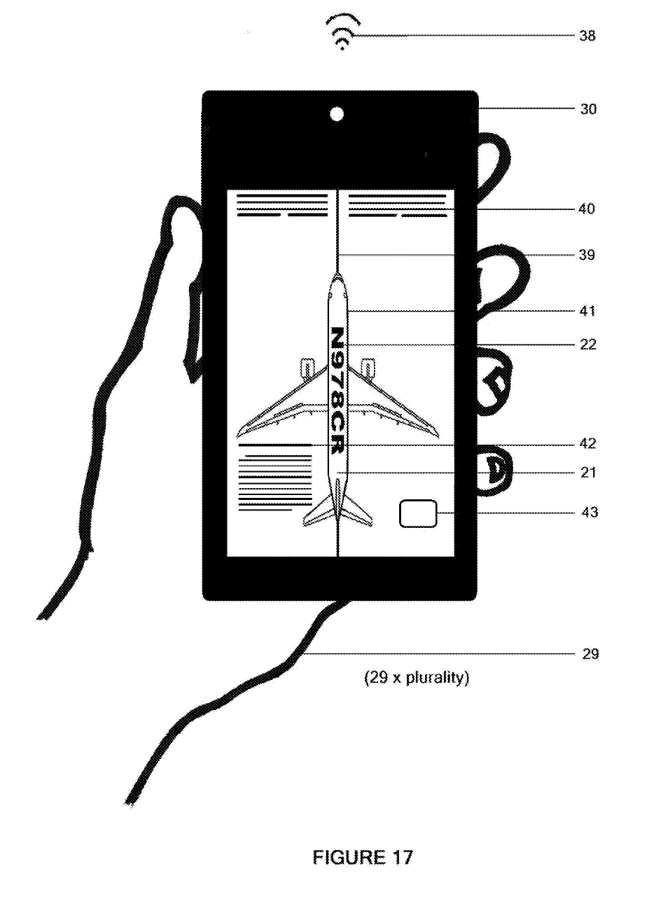

FIG. 17 Illustrates an electronic device, in the current instance, a cellular telephone 30, also known as a ‘smartphone’, being held by an end user(s) 29 in operational mode and displaying a virtual image 41 of in-route vehicle 20. A single, or plurality, as indicated via the expression, (29× plurality), of end-users 29, are similarly engaged in alternate locations. Providing assumptions of vehicle 20 as a commercial passenger aircraft in operation and transporting two hundred passengers, and providing assumptions of fifty percent of said two hundred passengers have relations monitoring in-route vehicle 20, such assumptions equal one hundred persons monitoring said in-route vehicle 20; thus a plurality. Assumptions may vary. A virtual visual image 41 of in-route vehicle 20 is displayed on end-users computerized electronic device 30, inclusive of its identifiers 22 on its fuselage topside 21, its parameters 40 inclusive of vehicle speed, altitude, vector, and flight line 39, integrated directives 42 and an alert icon 43 configured to alert authorities 48. End user(s) 29 is monitoring in-route vehicle 20. Its flight line 39 and parameters 40 and virtual visual image 41 indicate its systems are nominal. No further action is required of end user(s) 29 as indicated by directives 42.

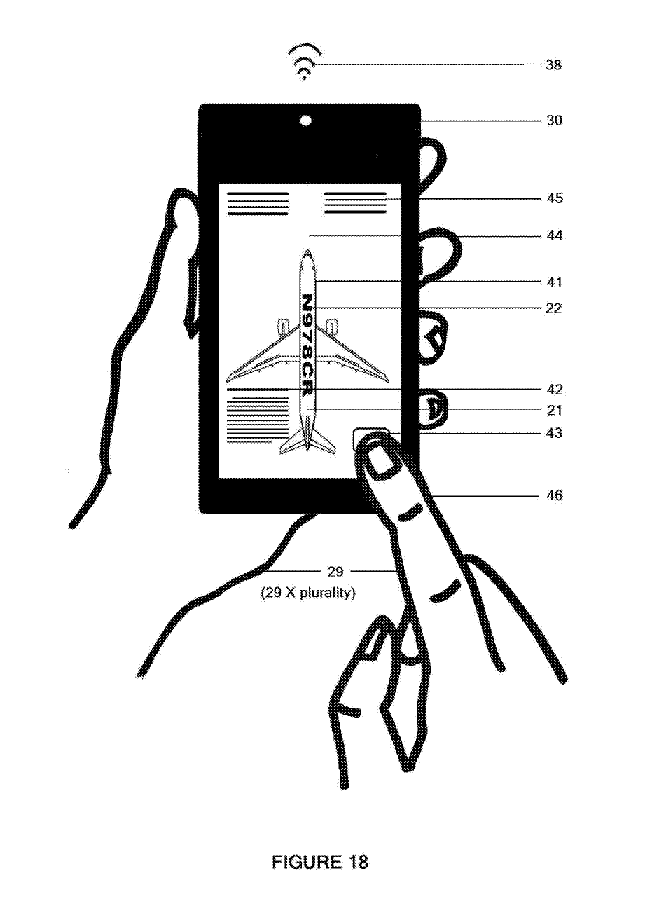

FIG. 18 Illustrates an electronic device, in the current instance, a cellular telephone 30, also known as a ‘smartphone’, being held by an end user(s) 29 in operational mode and displaying a virtual image 41 of in-route vehicle 20. A single, or plurality, as indicated via the expression, (29× plurality), of end-users 29, are similarly engaged in alternate locations. Providing assumptions of vehicle 20 as a commercial passenger aircraft in operation and transporting two hundred passengers, and providing assumptions of fifty percent of said two hundred passengers have relations monitoring in-route vehicle 20, such assumptions equal one hundred persons monitoring said in-route vehicle 20; thus a plurality. Assumptions may vary. A virtual visual image 41 of in-route vehicle 20 is displayed on end-users computerized electronic device 30, inclusive of its identifiers 22 on its fuselage topside 21, its parameters 45, inclusive of vehicle speed, altitude, vector, and line of flight 44, integrated directives 42 and an alert icon 43 configured to alert authorities 48. End user(s) 29 is monitoring in-route vehicle 20 and its flight line 44, parameters 45 inclusive of vehicle speed, altitude, vector, and line of flight, and virtual visual image 41 indicate its systems are not nominal. End-user(s) 29 are acting in a manner consistent with directives 42 and engaging alert icon 43. Assumptions of vehicle 20 as a commercial passenger aircraft in operation and transporting two hundred passengers, and providing assumptions of fifty percent of said two hundred passengers have relations monitoring in-route vehicle 20, such assumptions equal one hundred persons monitoring said in-route vehicle 20. Given said assumptions of one hundred persons monitoring in-route vehicle 20 and given assumptions of seventy-five percent of said one hundred persons engaging alert icon 43 as directed in lieu of in-route vehicle 20 flight line and parameters indicating in-route vehicle 20 flight line and parameters are not nominal 45, such assumption equates to seventy-five persons engaging alert icon. Thus, X equals seventy-five.

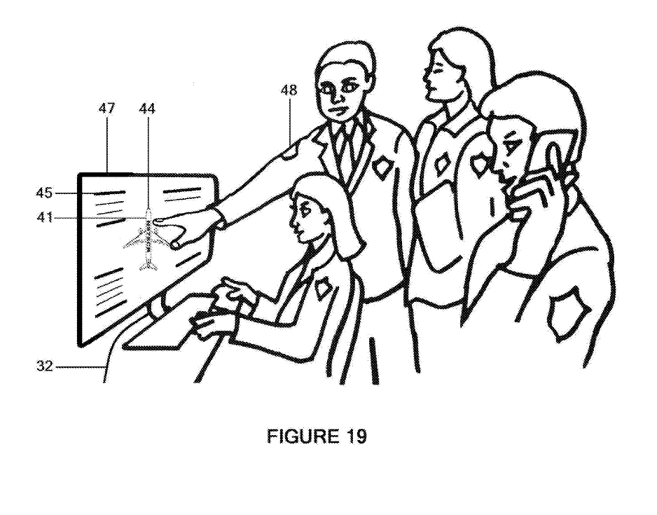

FIG. 19 Illustrates an authoritative entity(s) 48 receiving, reviewing and acting upon data (41, 44, 45) sent by an end-user(s) 29 and displayed on authorities computerized device 47 which is connected to the network of the World Wide Web 32. Authorities 48 are acting upon such real-time virtual visual vehicle data (41, 44, 45) in a manner consistent with addressing events occurring to in-route vehicle 20, such as it experiencing distress, safety concerns or terrorism events.

1. A system and methods for real-time virtual visual in route vehicle monitoring comprising: vehicles registered with identifiers; said vehicles being electronical communications and global positioning system (GPS) equipped; said vehicles being vehicle parameter equipped; manned or unmanned aerospace vehicles; said manned or unmanned aerospace vehicles being electronical communication and global positioning system equipped; said manned or unmanned aerospace vehicles being electronic imaging device equipped; parabolic antenna equipped to trans-pond electronic vehicle parameters and imaging data with said manned or unmanned aerospace vehicles; said parabolic antenna configured and connected to computerized network systems and servers and transfer said vehicle parameters inclusive of vehicle speed, altitude, vector, and line of flight and global positioning data therein; said manned or unmanned aerospace vehicles or satellites, said parabolic antenna and said computerized networks and servers configured to relay said vehicle's electronic imaging data and vehicle parameters therein; single or crowdsourced plurality of individuals or entities equipped with computerized devices, collectively, ‘end-users’; said single or crowdsourced plurality of individuals or entities, end-users, computerized devices configured to connect to said computerized network systems and servers; said single or crowdsourced plurality of individuals or entities, end-users, computerized devices equipped with a computerized software application; said software application configured to dynamically receive and send said electronic data with said computerized networks and servers; said software application configured to dynamically download and display said vehicle electronic images and parameters from said network systems and servers; said software application configured to display flight line of in-route vehicles planned flight route; said software application configured to display in-route vehicle's parameters; said software application configured to display end-user directives; said computerized software application configured with integrated application alert icon affording end-users ability to interface with said computerized software application; said software application's alert icon configured to directly relay alert to authority entities upon end-user's engaging.
A method of claim 1, wherein said vehicles are registered with identifiers on their topside.
A method of claim 1, wherein said vehicles are transportation vehicles.
A method of claim 1, wherein said aerospace imaging devices such as manned or unmanned aerospace vehicles or satellites are positioned at altitude above said vehicles.
A method of claim 1, wherein said transportation vehicles are in-route.
A method of claim 1, wherein said vehicle identifiers composite are paint mediums with photo-reflective qualities.
A method of claim 1, wherein said vehicle identifiers composite is alternatively electronical.
A method of claim 1, wherein said vehicle identifiers composites are alternatively paint mediums with photo-reflective qualities and electronical.
A method of claim 1, wherein said vehicle identifiers composite is alternatively electronical and electronically illuminates.
A method of claim 1, wherein said vehicle identifiers composite is alternatively material engineered for aerospace signage.
A method of claim 1, wherein said aerospace vehicles are manned or unmanned vehicles.
A method of claim 1, wherein said aerospace vehicles are aircraft, drones or satellites.
A method of claim 1, wherein said vehicles registered with identifiers and are electronical communication and global positioning system equipped trans-pond with said manned or unmanned aerospace vehicles which are electronical communication and global positioning system and digital electronic imaging device equipped.
A method of claim 1, wherein said manned or unmanned aerospace vehicles that are electronical communication and global positioning system and electronic imaging device equipped electronically image(s) said individual vehicles while said vehicles are in-route, and/or electronically image(s) in-route vehicle hubs, in-route vehicle corridors and in-route flight areas of said in-route vehicles.
A method of claim 1, wherein said manned or unmanned aerospace vehicles or satellites equipped with electronic imaging devices digitally signalize and dynamically relay said electronic image(s) data and vehicle parameters to ground-based parabolic antenna.
A method of claim 1, wherein said parabolic antenna relay said electronic image(s) of in-route vehicles, hubs, corridors and flight areas and in-route vehicle parameter data inclusive of vehicle speed, altitude, vector, and line of flight to computerized networks such as the World Wide Web and servers therein.
A method of claim 1, wherein relay of said in-route vehicle image(s) and parameters is dynamic.
A method of claim 1, wherein end-user(s) connect to said network with computerized devices.
A method of claim 1, wherein end-user(s) access said in-route vehicle's electronic imaging and parameters via a pre-downloaded software application on said computerized devices.
A method of claim 1, wherein said manned or unmanned aerospace vehicles electronically image(s) said vehicles which are electronical communication and global positioning system equipped while said vehicles are in-route and relay said electronic image(s) and vehicle parameter inclusive of vehicle speed, altitude, vector, and line of flight to said parabolic antenna in real-time and such electronic image(s) and parameters of in-route being relayed to said computerized networks in real-time and said end-user(s) accessing said electronic image(s) and parameters on said end-user's computerized devices in real-time.
A method of claim 1, wherein said software application displays a real-time flight line representative of said in-route vehicle's registered flight plan route.
A method of claim 1, wherein said software application displays real-time parameters of said vehicle on said end-user(s) computerized devices.
A method of claim 1, wherein said software application displays directives in relation to end-users interfacing.
A method of claim 1, wherein said directives direct end-user(s) how to engage in real-time when said vehicle parameters are nominal and said directives direct end-user(s) how to engage in real-time when said vehicle parameters are not nominal by and said directives explain said in-route vehicle may be experiencing distress, well-being concerns or potential terrorism events.
A method of claim 1, wherein said software application being integrated with alert icon for end-user(s) to engage as directed in said directives and of which directly alerts authorities in real-time upon occurrence of such potential events as; in-route vehicles experiencing distress, well-being concerns or terrorism events.
